(19) United States
(12) Patent Application Publication
(10) Pub. No.: US 2016/0353729 A1
(43) Pub. Date: Dec. 8, 2016

(54) Fluid Dispensing Assembly

(71) Applicants: John Benson, The Villages, FL (US); Nereida Benson, The Villages, FL (US)

(72) Inventors: John Benson, The Villages, FL (US); Nereida Benson, The Villages, FL (US)

(21) Appl. No.: 14/731,714

(22) Filed: Jun. 5, 2015

(51) Int. Cl. A01M 21/04; B05B 11/00

(52) U.S. Cl. CPC A01M 21/043; B05B 11/3042; B05B 11/0054

(57) ABSTRACT

A fluid dispensing assembly for discretely applying an herbicide to a plant includes a dispenser that may selectively release a fluid. The dispenser may be positioned proximate a plant such that the fluid is dispensed onto the plant. A container is removably coupled to the dispenser. The container contains a fluid such that the dispenser selectively releases the fluid.

### BACKGROUND OF THE DISCLOSURE

### Field of the Disclosure

The disclosure relates to dispensing devices and more particularly pertains to a new dispensing device for discretely applying an herbicide to a plant.

### SUMMARY OF THE DISCLOSURE

An embodiment of the disclosure meets the needs presented above by generally comprising a dispenser that may selectively release a fluid. The dispenser may be positioned proximate a plant such that the fluid is dispensed onto the plant. A container is removably coupled to the dispenser. The container contains a fluid such that the dispenser selectively releases the fluid.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a fluid dispensing assembly according to an embodiment of the disclosure.

FIG. 2 is a left side view of an embodiment of the disclosure.

FIG. 3 is a top view of an embodiment of the disclosure.

FIG. 4 is a left side exploded view of an embodiment of the disclosure.

FIG. 5 is a perspective in-use view of an embodiment of the disclosure.

### DESCRIPTION OF THE PREFERRED EMBODIMENT

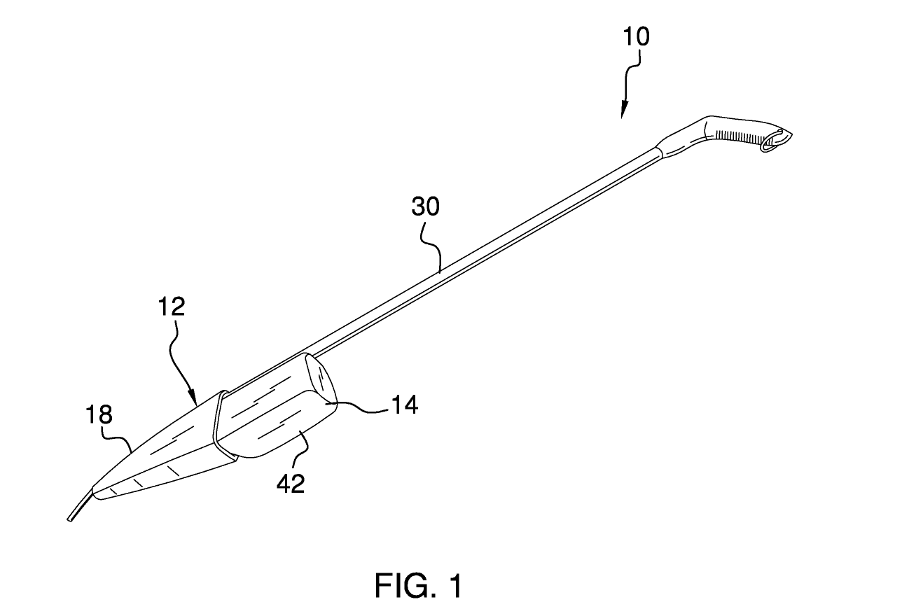

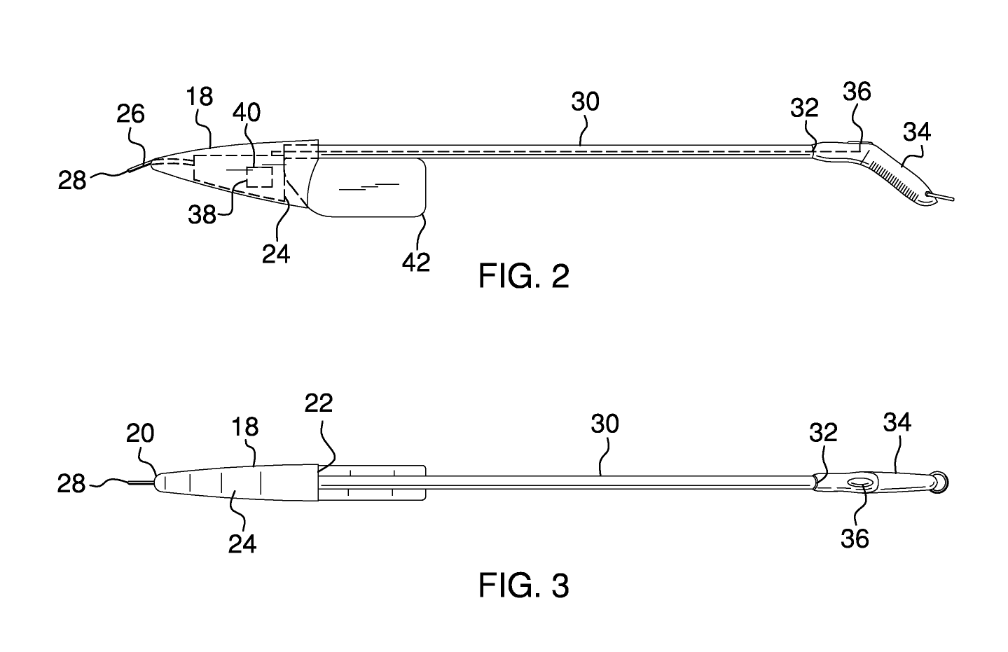

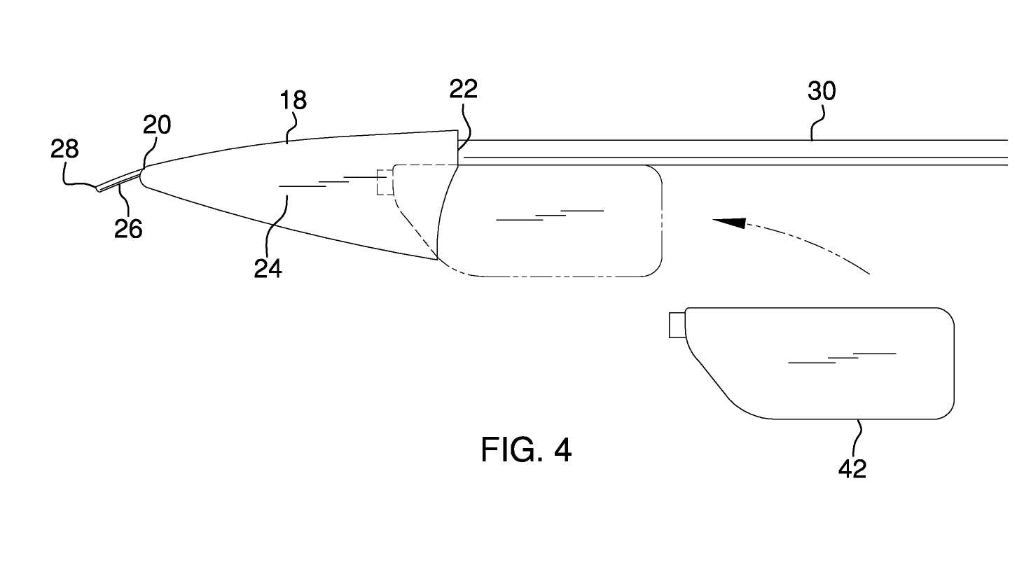

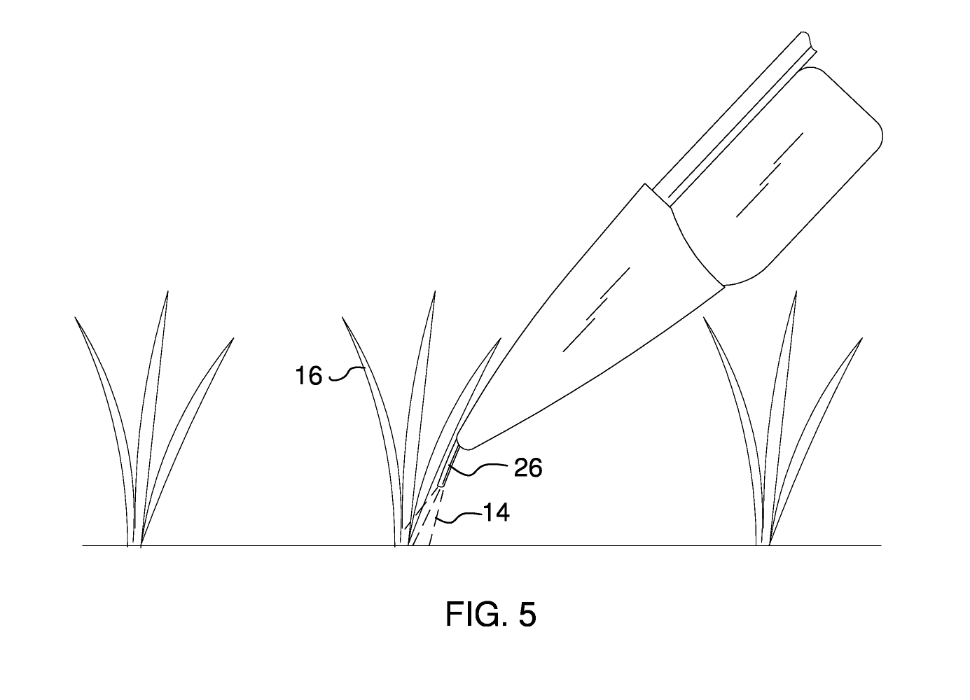

With reference now to the drawings, and in particular to FIGS. 1 through 5 thereof, a new dispensing device embodying the principles and concepts of an embodiment of the disclosure and generally designated by the reference numeral 10 will be described.

As best illustrated in FIGS. 1 through 5, the fluid dispensing assembly 10 generally comprises a dispenser 12 that may selectively release a fluid 14. The dispenser 12 may be positioned proximate a plant 16 such that the fluid 14 is dispensed onto the plant 16. The fluid 14 may comprise a liquid herbicide or the like and the plant 16 may be any undesired plant.

The dispenser 12 comprises a receiver 18 that has a first end 20, a second end 22 and a peripheral wall 24 extending between the first end 20 and the second end 22. The second end 22 is open and a pump 24 is positioned within the receiver 18. The pump 24 may comprise an electric fluid pump or the like.

A nozzle 26 extends away from the first end 20 of the receiver 18 and the nozzle 26 is fluidly coupled to the pump 24. Thus, the nozzle 26 may have the fluid 14 urged therethrough. The nozzle 26 has a distal end 28 with respect to the receiver 18 such that the distal end 28 may be positioned proximate the plant 16. The distal end 28 is open such that the nozzle 26 may dispense the fluid 14 onto the plant 16.

A rod 30 is coupled to and extends away from the receiver 18 such that the rod 30 may be gripped. The rod 30 has a distal end 32 with respect to the receiver 18 and a handle 34 is coupled to the distal end 32 of the rod 30. The handle 34 may curve downwardly from the distal end 32 of the rod 30 thereby enhancing gripping of the handle 34.

A switch 36 is coupled to the handle 34 such that the switch 36 may be manipulated. The switch 36 is electrically coupled to the pump 24 such that the switch 36 selectively turns the pump 24 on and off. A power supply 38 is positioned within the receiver 18 and the power supply 38 is electrically coupled to the pump 24. The power supply 38 comprises at least one battery 40.

A container 42 is removably coupled to the dispenser 12 and the container 42 contains the fluid 14. The container 42 is removably positioned within the second end 22 of the receiver 18 such that the container 42 is fluidly coupled to the pump 24. Thus, the pump 24 urges the fluid 14 outwardly through the nozzle 26 when the switch 36 is manipulated.

In use, the rod 30 and the handle 34 are gripped such that the nozzle 26 is positioned proximate the plant 16 that is to be soaked with the fluid 14. The switch 36 is manipulated and the fluid 14 is distributed onto the plant 16. The nozzle 26 facilitates the fluid 14 to be discretely applied to the plant 16 with respect to adjacent plants 16. Thus, selected plants 16 may have the fluid 14 applied thereto in the convention of weed control.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fluid dispensing assembly configured to dispense a fluid onto a plant, said assembly comprising:
a dispenser being configured to selectively release a fluid, said dispenser being configured to be positioned proximate a plant such that the fluid is dispensed onto the plant; and
a container being removably coupled to said dispenser, said container being configured to contain a fluid wherein said dispenser selectively releases the fluid.

2. The assembly according to claim 1, wherein said dispenser comprises a receiver having a first end, a second end and a peripheral wall extending between said first end and said second end, said second end being open.

3. The assembly according to claim 2, further comprising:
a pump being positioned within said receiver; and
a nozzle extending away from said first end of said receiver, said nozzle being fluidly coupled to said pump wherein said nozzle is configured to have the fluid urged therethrough, said nozzle having a distal end with respect to said receiver wherein said distal end is configured to be positioned proximate the plant, said distal end being open wherein said nozzle is configured to dispense the fluid onto the plant.

4. The assembly according to claim 3, further comprising:
a rod being coupled to and extending away from said receiver wherein said rod is configured to be gripped, said rod having a distal end with respect to said receiver; and
a handle being coupled to said distal end of said rod.

5. The assembly according to claim 4, further comprising a switch coupled to said handle wherein said switch is configured to be manipulated, said switch being electrically coupled to said pump wherein said switch selectively turns said pump on and off.

6. The assembly according to claim 5, further comprising a power supply being positioned within said receiver, said power supply being electrically coupled to said pump, said power supply comprising at least one battery.

7. The assembly according to claim 1, further comprising:
a receiver having a second end;
a pump;
a nozzle; and
said container being removably positioned within said second end of said receiver such that said container is fluidly coupled to said pump wherein said pump urges the fluid outwardly through said nozzle.

8. A fluid dispensing assembly configured to dispense a fluid onto a plant, said assembly comprising:
a dispenser being configured to selectively release a fluid, said dispenser being configured to be positioned proximate a plant such that the fluid is dispensed onto the plant, said dispenser comprising:
a receiver having a first end, a second end and a peripheral wall extending between said first end and said second end, said second end being open,
a pump being positioned within said receiver,
a nozzle extending away from said first end of said receiver, said nozzle being fluidly coupled to said pump wherein said nozzle is configured to have the fluid urged therethrough, said nozzle having a distal end with respect to said receiver wherein said distal end is configured to be positioned proximate the plant, said distal end being open wherein said nozzle is configured to dispense the fluid onto the plant,
a rod being coupled to and extending away from said receiver wherein said rod is configured to be gripped, said rod having a distal end with respect to said receiver,
a handle being coupled to said distal end of said rod,
a switch coupled to said handle wherein said switch is configured to be manipulated, said switch being electrically coupled to said pump wherein said switch selectively turns said pump on and off, and
a power supply being positioned within said receiver, said power supply being electrically coupled to said pump, said power supply comprising at least one battery; and
a container being removably coupled to said dispenser, said container being configured to contain a fluid wherein said dispenser selectively releases the fluid, said container being removably positioned within said second end of said receiver such that said container is fluidly coupled to said pump wherein said pump urges the fluid outwardly through said nozzle.
